(19) United States
(12) Patent Application Publication
(10) Pub. No.: US 2026/0281935 A1
(43) Pub. Date: Sep. 17, 2026

(54) ROAMING MANAGEMENT METHOD

(71) Applicant: LG ELECTRONICS INC., Seoul (KR)

(72) Inventors: Hyunjung CHOE, Seoul (KR); Sunhee KIM, Seoul (KR)

(73) Assignee: LG ELECTRONICS INC., Seoul (KR)

(21) Appl. No.: 19/472,873

(22) PCT Filed: Mar. 26, 2024
(86) PCT No.: PCT/KR2024/003750

§ 371 Date: Oct. 6, 2025

Related U.S. Application Data
(60) Provisional application No. 63/457,387, filed on Apr. 5, 2023.

(51) Int. Cl. H04W 60/00; H04W 8/06; H04W 48/18; H04W 84/04

(52) U.S. Cl. CPC H04W 60/001; H04W 8/06; H04W 48/18; H04W 84/042

(57) ABSTRACT

A disclosure of the present specification provides a method for performing communication by a UE. The method comprises the steps of: transmitting a registration request message to a visited public land mobile network (VPLMN); receiving a registration reject message from the VPLMN, the registration reject message including roaming assistance information; and performing network selection on the basis of the roaming assistance information.

### CROSS-REFERENCE TO RELATED APPLICATION(S)

This application is the National Stage filing under 35 U.S.C. 371 of International Application No. PCT/KR2024/003750, filed on Mar. 26, 2024, which claims the benefit of U.S. Provisional Application No. 63/457,387, filed on Apr. 5, 2023, the contents of which are all incorporated by reference herein in their entirety.

### TECHNICAL FIELD

The present specification relates to mobile communications.

### BACKGROUND ART

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

Previously, registration accept was required to transmit roaming-related information (e.g., SoR) to a terminal, which was problematic.

### SUMMARY

The network rejects the terminal's registration request and sends roaming assistant information to the terminal.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIG. 4 is a block diagram of a next generation cellular network.

FIG. 5 illustrates an example 5G system structure to which an implementation of the present specification may be applied.

FIGS. 6 and 7 show an example of a registration procedure to which implementations of the present disclosure is applied.

FIG. 8 shows a procedure according to an embodiment of the present specification.

FIG. 9 shows the procedure of the UE according to disclosure of the present specification.

FIG. 10 shows the procedure of the VPLMN according to disclosure of the present specification.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. Evolution of 3GPP LTE includes LTE-A (advanced), LTE-A Pro, and/or 5G NR (new radio).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

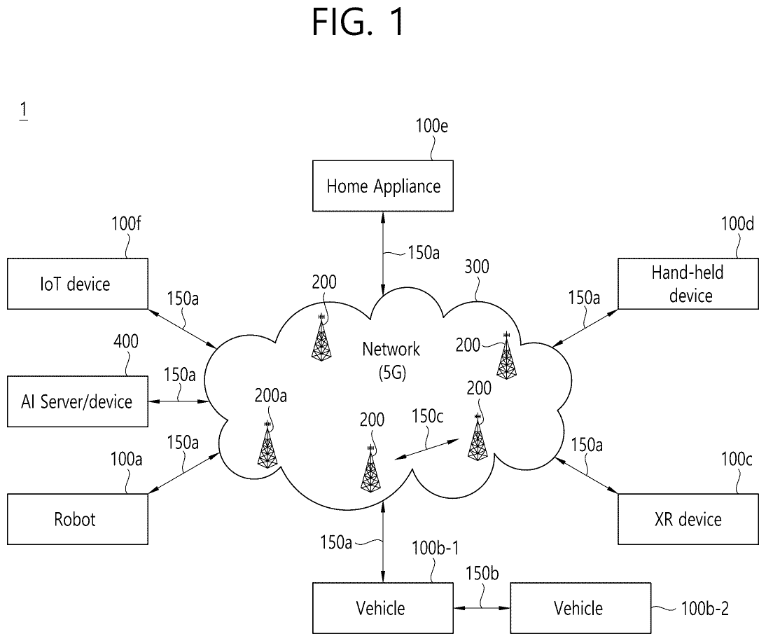

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

AI refers to the field of studying artificial intelligence or the methodology that can create it, and machine learning refers to the field of defining various problems addressed in the field of AI and the field of methodology to solve them. Machine learning is also defined as an algorithm that increases the performance of a task through steady experience on a task.

Robot means a machine that automatically processes or operates a given task by its own ability. In particular, robots with the ability to recognize the environment and make self-determination to perform actions can be called intelligent robots. Robots can be classified as industrial, medical, home, military, etc., depending on the purpose or area of use. The robot can perform a variety of physical operations, such as moving the robot joints with actuators or motors. The movable robot also includes wheels, brakes, propellers, etc., on the drive, allowing it to drive on the ground or fly in the air.

Autonomous driving means a technology that drives on its own, and autonomous vehicles mean vehicles that drive without user's control or with minimal user's control. For example, autonomous driving may include maintaining lanes in motion, automatically adjusting speed such as adaptive cruise control, automatic driving along a set route, and automatically setting a route when a destination is set. The vehicle covers vehicles equipped with internal combustion engines, hybrid vehicles equipped with internal combustion engines and electric motors, and electric vehicles equipped with electric motors, and may include trains, motorcycles, etc., as well as cars. Autonomous vehicles can be seen as robots with autonomous driving functions.

Extended reality is collectively referred to as VR, AR, and MR. VR technology provides objects and backgrounds of real world only through computer graphic (CG) images. AR technology provides a virtual CG image on top of a real object image. MR technology is a CG technology that combines and combines virtual objects into the real world. MR technology is similar to AR technology in that they show real and virtual objects together. However, there is a difference in that in AR technology, virtual objects are used as complementary forms to real objects, while in MR technology, virtual objects and real objects are used as equal personalities.

NR supports multiples numerologies (and/or multiple subcarrier spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., FR1 and FR2. The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

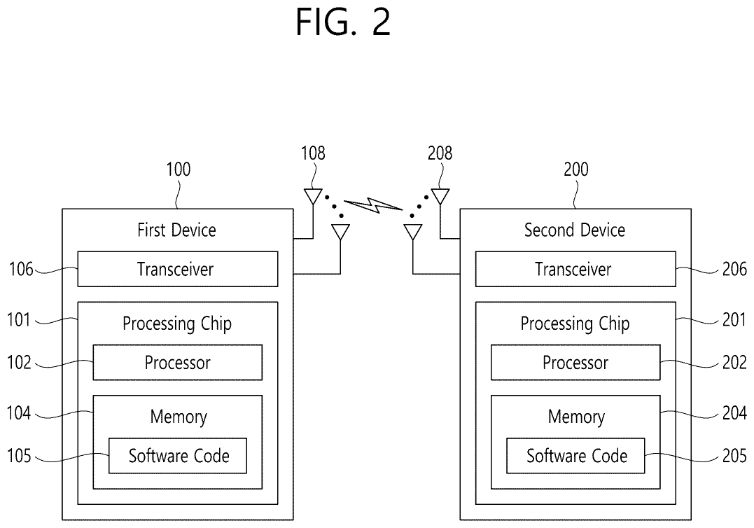

FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104, 204 may be associated with the one or more processors 102, 202 and may store various forms of data, signals, messages, information, programs, codes, instructions, and/or commands. The one or more memories 104, 204 may comprise random access memory (RAM), dynamic RAM (DRAM), read-only memory (ROM), erasable programmable ROM (EPROM), flash memory, volatile memory, non-volatile memory, hard drives, registers, cache memory, computer-readable storage media, and/or combinations thereof. The one or more memories 104, 204 may be located inside and/or outside of the one or more processors 102, 202. Further, the one or more memories 104, 204 may be coupled to the one or more processors 102, 202 via various technologies, such as wired or wireless connections.

The one or more transceivers 106, 206 may transmit user data, control information, wireless signals/channels, etc. referred to in the descriptions, features, procedures, suggestions, methods, and/or flowcharts of operation disclosed herein to one or more other devices. The one or more transceivers 106, 206 may receive user data, control information, wireless signals/channels, etc. referred to in the descriptions, features, procedures, suggestions, methods, and/or flowcharts of operation disclosed herein from one or more other devices. For example, the one or more transceivers 106, 206 may be associated with the one or more processors 102, 202 and may transmit and receive wireless signals. For example, the one or more processors 102, 202 may control the one or more transceivers 106, 206 to transmit user data, control information, wireless signals, etc. to one or more other devices. Further, the one or more processors 102, 202 may control the one or more transceivers 106, 206 to receive user data, control information, wireless signals, etc. from the one or more other devices.

The one or more transceivers 106, 206 may be associated with one or more antennas 108, 208. Additionally and/or alternatively, the one or more transceivers 106, 206 may include one or more antennas 108, 208. The one or more transceivers 106, 206 may be configured to transmit and receive, via the one or more antennas 108, 208, user data, control information, wireless signals/channels, etc. referred to in the descriptions, features, procedures, suggestions, methods, and/or flowcharts of operation disclosed herein. As used herein, the one or more antennas 108, 208 may be a plurality of physical antennas, or a plurality of logical antennas (e.g., antenna ports).

The one or more transceivers 106, 206 may convert the received user data, control information, radio signals/channels, etc. from RF band signals to baseband signals in order to process the received user data, control information, radio signals/channels, etc. using the one or more processors 102, 202. The one or more transceivers 106, 206 may convert the processed user data, control information, radio signals/channels, etc. from baseband signals to RF band signals using the one or more processors 102, 202. To do so, the one or more transceivers 106, 206 may include (analog) oscillators and/or filters. For example, the one or more transceivers 106, 206 may up-convert an OFDM baseband signal to an OFDM signal via an (analog) oscillator and/or filter under the control of the one or more processors 102, 202, and transmit the up-converted OFDM signal at the carrier frequency. The one or more transceivers 106, 206 may receive the OFDM signal at the carrier frequency and, under the control of the one or more processors 102, 202, down-convert the OFDM signal to an OFDM baseband signal via an (analog) oscillator and/or filter.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

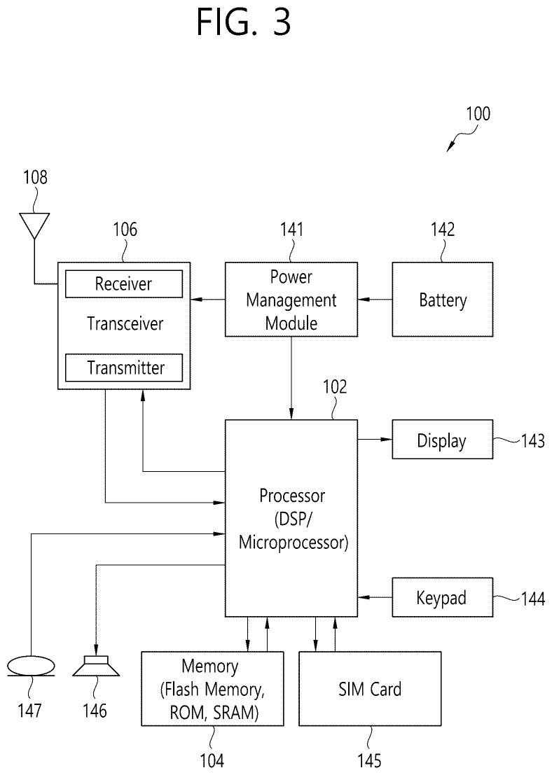

FIG. 3 shows an example of UE to which implementations of the present disclosure is applied.

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

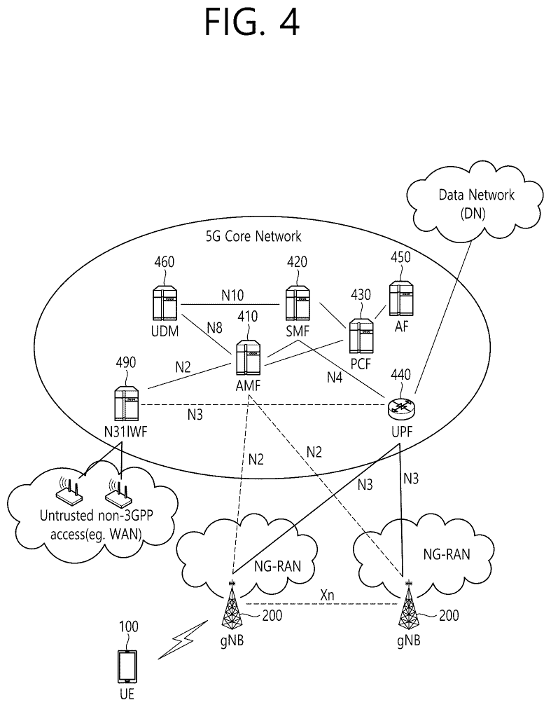

FIG. 4 is a block diagram of a next generation cellular network.

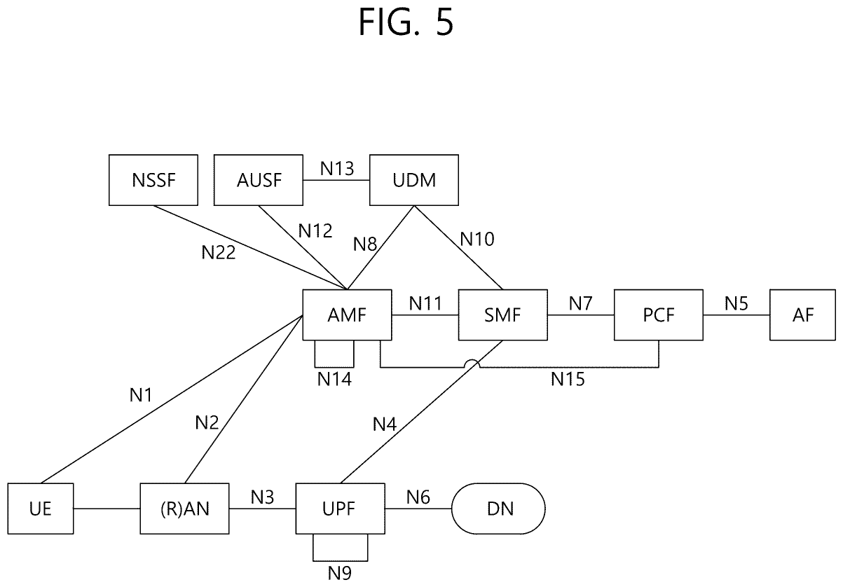

The 5G Core (5GC) may include a variety of components, some of which are shown in FIG. 5, such as the Access and Mobility Management Function (AMF) (410), the Session Management Function (SMF) (420), the Policy Control Function (PCF) (430), the User Plane Function (UPF) (440), the Application Function (AF) (450), the UDF (UDF) (450), and the UDF (UDF) (450): Policy Control Function (PCF) (430), User Plane Function (UPF) (440), Application Function (AF) (450), Unified Data Management (UDM) (460), and Non-3rd Generation Partnership Project (3GPP) Inter Working Function (N3IWF) (490).

The UE 100 is connected to the data network via the UPF 440 through a next generation radio access network (NG-RAN) including the gNB 20.

The UE 100 may also be provided data services via untrusted non-3GPP access, such as a wireless local area network (WLAN). To connect said non-3GPP access to the core network, a N3IWF 490 may be deployed.

The illustrated N3IWF 490 performs the function of managing the interworking between the non-3GPP access and the 5G system. When the UE 100 is associated with a non-3GPP access (e.g., WiFi, also referred to as IEEE 801.11), the UE 100 may be associated with the 5G system via the N3IWF 490. The N3IWF 490 communicates with the AMF 410 for control signaling and with the UPF 440 via the N3 interface for data transfer.

The illustrated AMF 410 may manage access and mobility in a 5G system. The AMF 410 may perform functions to manage Non-Access Stratum (NAS) security. The AMF 410 may perform functions to handle mobility in an idle state.

The UPF 440 shown is a type of gateway through which user data is transmitted and received. The UPF node 440 may perform all or part of the user plane functions of the Serving Gateway (S-GW) and Packet Data Network Gateway (P-GW) of fourth generation mobile communications.

The UPF 440 acts as a demarcation point between the next generation radio access network (NG-RAN) and the core network, and is the element that maintains the data path between the gNB 20 and the SMF 420. Additionally, the UPF 440 acts as a mobility anchor point when the UE 100 moves across the area served by the gNB 20. The UPF 440 may perform functions to handle PDUs. For mobility within the NG-RAN (Next Generation-Radio Access Network as defined in 3GPP Release-15 and later), the UPF may route packets. The UPF 440 may also function as an anchor point for mobility with other 3GPP networks (RANs defined prior to 3GPP Release-15, e.g., UTRAN, E-UTRAN (Evolved-UMTS (Universal Mobile Telecommunications System) Terrestrial Radio Access Network), or GERAN (Global System for Mobile Communication (GSM)/EDGE (Enhanced Data rates for Global Evolution) Radio Access Network). The UPF 440 may correspond to a termination point of the data interface to the data network.

The PCF 430 shown is a node that controls the operator's policies.

The AF 450 shown is a server for providing multiple services to the UE 100.

The UDM 460 shown is a type of server that manages subscriber information, such as a home subscriber server (HSS) in fourth generation mobile communications. The UDM 460 stores and manages subscriber information in a unified data repository (UDR).

The SMF 420 shown may perform the function of assigning an Internet Protocol (IP) address of a UE. The SMF 420 may also control protocol data unit (PDU) sessions.

As a point of reference, the drawing symbols for AMF 410, SMF 420, PCF 430, UPF 440, AF 450, UDM 460, N3IWF 490, gNB 20, or UE 100 may be omitted herein.

Fifth generation mobile communications supports multiple numerologies or subcarrier spacings (SCS) to support various 5G services. For example, an SCS of 15 kHz supports wide area coverage in traditional cellular bands; an SCS of 30 kHz/60 kHz supports dense-urban, lower latency, and wider carrier bandwidth; and an SCS of 60 kHz or higher supports bandwidths greater than 24.25 GHz to overcome phase noise.

FIG. 5 illustrates an example 5G system structure to which an implementation of the present specification may be applied.

The 5G system (5GS; 5G system) structure consists of the following network functions (NFs).
AUSF (Authentication Server Function)
AMF (Access and Mobility Management Function)
DN (Data Network), e.g., operator services, internet access or third-party services
USDF (Unstructured Data Storage Function)
NEF (Network Exposure Function)
I-NEF (Intermediate NEF)
NRF (Network Repository Function)
NSSF (Network Slice Selection Function)
PCF (Policy Control Function)
SMF (Session Management Function)
UDM (Unified Data Management)
UDR (Unified Data Repository)
UPF (User Plane Function)
UCMF (UE radio Capability Management Function)
AF (Application Function)
UE (User Equipment)
(R)AN ((Radio) Access Network)
5G-EIR (5G-Equipment Identity Register)
NWDAF (Network Data Analytics Function)
CHF (Charging Function)

In addition, the following network functions may be considered.
N3IWF (Non-3GPP InterWorking Function)
TNGF (Trusted Non-3GPP Gateway Function)
W-AGF (Wireline Access Gateway Function)

FIG. 5 shows the 5G system structure of a non-roaming case using a reference point representation that shows how various network functions interact with each other.

In FIG. 5, UDSF, NEF and NRF are not described for clarity of the point-to-point diagram. However, all network functions shown may interact with UDSF, UDR, NEF and NRF as needed.

For clarity, the connection between the UDR and other NFs (e.g., PCFs) is not shown in FIG. 5. For clarity, the connection between NWDAF and other NFs (e.g. PCFs) is not shown in FIG. 5.

The 5G system architecture includes the following reference points.
N1: the reference point between the UE and the AMF.
N2: reference point between (R)AN and AMF.
N3: Reference point between (R)AN and UPF.
N4: reference point between SMF and UPF.
N6: Reference point between UPF and data network.
N9: reference point between two UPFs.

The following reference points show the interactions that exist between NF services in NF.
N5: Reference point between PCF and AF.
N7: reference point between SMF and PCF.
N8: reference point between UDM and AMF.
N10: reference point between UDM and SMF.
N11: reference point between AMF and SMF.
N12: reference point between AMF and AUSF.
N13: reference point between UDM and AUSF.
N14: reference point between two AMFs.
N15: Reference point between PCF and AMF in case of non-roaming scenario, and reference point between PCF and AMF of visited network in case of roaming scenario.
N16: reference point between two SMFs (in case of roaming, between the SMF of the visited network and the SMF of the home network)
N22: reference point between AMF and NSSF.

In some cases, it may be necessary to connect two NFs to each other to service the UE.

### <Registration Procedure>

A registration procedure is described. Section 4.2.2.2 of 3GPP TS 23.502 V16.3.0 (2019-12) can be referred.

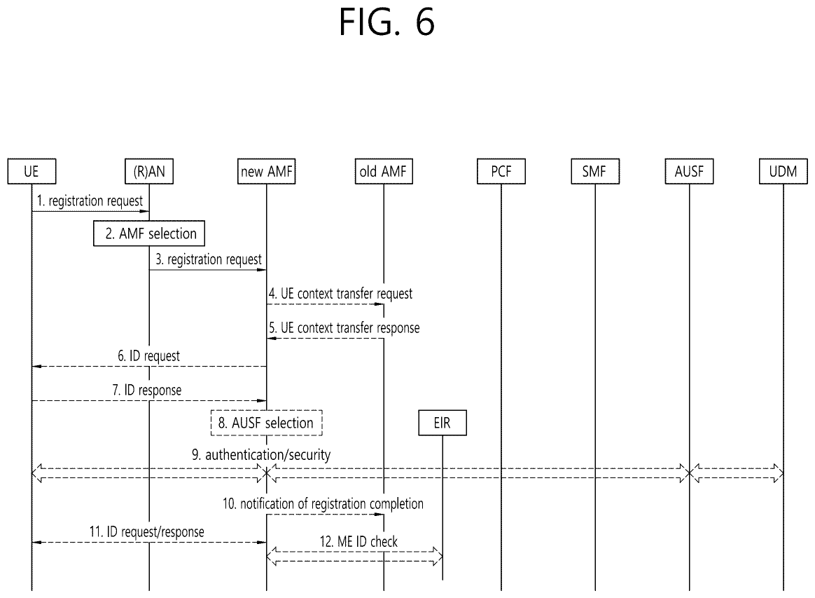

FIGS. 6 and 7 show an example of a registration procedure to which implementations of the present disclosure is applied.

A UE needs to register with the network to get authorized to receive services, to enable mobility tracking and to enable reachability. The UE initiates the registration procedure using one of the following registration types:
Initial registration to the 5GS; or
Mobility registration update; or
Periodic registration update; or
Emergency registration.

The general registration procedure in FIGS. 6 and 7 applies on all these registration procedures, but the periodic registration update need not include all parameters that are used in other registration cases.

The general registration procedure in FIGS. 6 and 7 is also used for the case of registration in 3GPP access when the UE is already registered in a non-3GPP access, and vice versa. Registration in 3GPP access when the UE is already registered in a non-3GPP access scenario may require an AMF change.

First, procedures of FIG. 6 are described.

(1) Step 1: The UE transmits a Registration Request message to the (R)AN. The Registration Request message corresponds to AN message.

The Registration Request message may include AN parameters. In the case of NG-RAN, the AN parameters include, e.g., 5G SAE temporary mobile subscriber identity (5G-S-TMSI) or globally unique AMF ID (GUAMI), the selected public land mobile network (PLMN) ID (or PLMN ID and network identifier (NID)) and Requested network slice selection assistance information (NSSAI). The AN parameters also include establishment cause. The establishment cause provides the reason for requesting the establishment of an RRC connection. Whether and how the UE includes the Requested NSSAI as part of the AN parameters is dependent on the value of the access stratum connection establishment NSSAI inclusion mode parameter.

The Registration Request message may include a registration type. The registration type indicates if the UE wants to perform an initial registration (i.e., the UE is in RM-DEREGISTERED state), a mobility registration update (i.e., the UE is in RM-REGISTERED state and initiates a registration procedure due to mobility or due to the UE needs to update its capabilities or protocol parameters, or to request a change of the set of network slices it is allowed to use), a periodic registration update (i.e., the UE is in RM-REGISTERED state and initiates a registration procedure due to the periodic registration update timer expiry) or an emergency registration (i.e., the UE is in limited service state).

When the UE is performing an initial registration, the UE shall indicate its UE identity in the Registration Request message as follows, listed in decreasing order of preference:
i) a 5G globally unique temporary identifier (5G-GUTI) mapped from an evolved packet system (EPS) GUTI, if the UE has a valid EPS GUTI.
ii) a native 5G-GUTI assigned by the PLMN to which the UE is attempting to register, if available;
iii) a native 5G-GUTI assigned by an equivalent PLMN to the PLMN to which the UE is attempting to register, if available;
iv) a native 5G-GUTI assigned by any other PLMN, if available.
v) Otherwise, the UE shall include its subscriber concealed identifier (SUCI) in the Registration Request message.

When the UE performing an initial registration has both a valid EPS GUTI and a native 5G-GUTI, the UE shall also indicate the native 5G-GUTI as additional GUTI. If more than one native 5G-GUTIs are available, the UE shall select the 5G-GUTI in decreasing order of preference among items (ii)-(iv) in the list above.

When the UE is performing an initial registration with a native 5G-GUTI, then the UE shall indicate the related GUAMI information in the AN parameters. When the UE is performing an initial registration with its SUCI, the UE shall not indicate any GUAMI information in the AN parameters.

For an emergency registration, the SUCI shall be included if the UE does not have a valid 5G-GUTI available; the permanent equipment identifier (PEI) shall be included when the UE has no subscriber permanent identifier (SUPI) and no valid 5G-GUTI. In other cases, the 5G-GUTI is included and it indicates the last serving AMF.

The Registration Request message may also include security parameters, PDU Session Status, etc. The security parameters are used for authentication and integrity protection. The PDU Session Status indicates the previously established PDU sessions in the UE. When the UE is connected to the two AMFs belonging to different PLMN via 3GPP access and non-3GPP access then the PDU Session status indicates the established PDU Session of the current PLMN in the UE.

(2) Step 2: The (R)AN selects an AMF.

If a 5G-S-TMSI or GUAMI is not included or the 5G-S-TMSI or GUAMI does not indicate a valid AMF, the (R)AN, based on (R) AT and requested NSSAI, if available, selects an AMF.

If UE is in CM-CONNECTED state, the (R)AN can forward the Registration Request message to the AMF based on the N2 connection of the UE.

If the (R)AN cannot select an appropriate AMF, it forwards the Registration Request message to an AMF which has been configured, in the (R)AN, to perform AMF selection.

(3) Step 3: The (R)AN transmits a Registration Request message to the new AMF. The Registration Request message corresponds to N2 message.

The Registration Request message may include whole information and/or a part of information included in the Registration Request message received from the UE which is described in step 1.

The Registration Request message may include N2 parameters. When NG-RAN is used, the N2 parameters include the selected PLMN ID (or PLMN ID and NID), location information and cell identity related to the cell in which the UE is camping, UE context request which indicates that a UE context including security information needs to be setup at the NG-RAN. When NG-RAN is used, the N2 parameters shall also include the establishment cause.

If the Registration type indicated by the UE is Periodic Registration Update, then steps 4 to 19 may be omitted.

(4) Step 4: If the UE's 5G-GUTI was included in the Registration Request message and the serving AMF has changed since last registration procedure, the new AMF may invoke the Namf_Communication_UEContextTransfer service operation on the old AMF including the complete registration request non-access stratum (NAS) message to request the UE's SUPI and UE context.

(5) Step 5: The Old AMF may respond to the new AMF for the Namf_Communication_UEContextTransfer invocation by including the UE's SUPI and UE context.

(6) Step 6: If the SUCI is not provided by the UE nor retrieved from the old AMF, the identity request procedure may be initiated by the new AMF sending the Identity Request message to the UE requesting the SUCI.

(7) Step 7: The UE may respond with an Identity Response message including the SUCI. The UE derives the SUCI by using the provisioned public key of the home PLMN (HPLMN).

(8) Step 8: The new AMF may decide to initiate UE authentication by invoking an AUSF. In that case, the new AMF selects an AUSF based on SUPI or SUCI.

(9) Step 9: Authentication/security may be established by the UE, new AMF, AUSF and/or UDM.

(10) Step 10: If the AMF has changed, the new AMF may notify the old AMF that the registration of the UE in the new AMF is completed by invoking the Namf_Communication_RegistrationCompleteNotify service operation. If the authentication/security procedure fails, then the registration shall be rejected, and the new AMF may invoke the Namf_Communication_RegistrationCompleteNotify service operation with a reject indication reason code towards the old AMF. The old AMF may continue as if the UE context transfer service operation was never received.

(11) Step 11: If the PEI was not provided by the UE nor retrieved from the old AMF, the Identity Request procedure may be initiated by the new AMF sending an Identity Request message to the UE to retrieve the PEI. The PEI shall be transferred encrypted unless the UE performs emergency registration and cannot be authenticated.

(12) Step 12: Optionally, the new AMF may initiate ME identity check by invoking the N5g-eir_EquipmentIdentityCheck_Get service operation.

Now, procedures of FIG. 7, which follow the procedures of FIG. 6, are described.

(13) Step 13: If step 14 below is to be performed, the new AMF, based on the SUPI, may select a UDM, then UDM may select a UDR instance.

(14) Step 14: The new AMF may register with the UDM.

(15) Step 15: The new AMF may select a PCF.

(16) Step 16: The new AMF may optionally perform an AM Policy Association Establishment/Modification.

(17) Step 17: The new AMF may transmit Update/Release SM Context message (e.g., Nsmf_PDUSession_UpdateSMContext and/or Nsmf_PDUSession_ReleaseSMContext) to the SMF.

(18) Step 18: If the new AMF and the old AMF are in the same PLMN, the new AMF may send a UE Context Modification Request to the N3IWF/TNGF/W-AGF.

(19) Step 19: The N3IWF/TNGF/W-AGF may send a UE Context Modification Response to the new AMF.

(20) Step 20: After the new AMF receives the response message from the N3IWF/TNGF/W-AGF in step 19, the new AMF may register with the UDM.

(21) Step 21: The new AMF transmits a Registration Accept message to the UE.

The new AMF sends a Registration Accept message to the UE indicating that the Registration Request has been accepted. 5G-GUTI is included if the new AMF allocates a new 5G-GUTI. If the UE is already in RM-REGISTERED state via another access in the same PLMN, the UE shall use the 5G-GUTI received in the Registration Accept message for both registrations. If no 5G-GUTI is included in the Registration Accept message, then the UE uses the 5G-GUTI assigned for the existing registration also for the new registration. If the new AMF allocates a new registration area, it shall send the registration area to the UE via Registration Accept message. If there is no registration area included in the Registration Accept message, the UE shall consider the old registration area as valid. Mobility Restrictions is included in case mobility restrictions applies for the UE and registration type is not emergency registration. The new AMF indicates the established PDU sessions to the UE in the PDU Session status. The UE removes locally any internal resources related to PDU sessions that are not marked as established in the received PDU Session status. When the UE is connected to the two AMFs belonging to different PLMN via 3GPP access and non-3GPP access then the UE removes locally any internal resources related to the PDU session of the current PLMN that are not marked as established in received PDU Session status. If the PDU Session status information was in the Registration Request message, the new AMF shall indicate the PDU Session status to the UE.

The Allowed NSSAI provided in the Registration Accept message is valid in the registration area and it applies for all the PLMNs which have their tracking areas included in the registration area. The Mapping Of Allowed NSSAI is the mapping of each S-NSSAI of the Allowed NSSAI to the HPLMN S-NSSAIs. The Mapping Of Configured NSSAI is the mapping of each S-NSSAI of the Configured NSSAI for the serving PLMN to the HPLMN S-NSSAIS.

Furthermore, optionally the new AMF performs a UE Policy Association Establishment.

(22) Step 22: The UE may send a Registration Complete message to the new AMF when it has successfully updated itself.

The UE may send a Registration Complete message to the new AMF to acknowledge if a new 5G-GUTI was assigned.

(23) Step 23: For registration over 3GPP Access, if the new AMF does not release the signaling connection, the new AMF may send the RRC Inactive Assistance Information to the NG-RAN. For registration over non-3GPP Access, if the UE is also in CM-CONNECTED state on 3GPP access, the new AMF may send the RRC Inactive Assistance Information to the NG-RAN.

(24) Step 24: The new AMF may perform information update towards the UDM.

(25) Step 25: The UE may execute Network Slice-Specific Authentication and Authorization procedure.

### <SOR (Steering of Roaming)>

SOR (Steering of Roaming) is a technique whereby a roaming UE is encouraged to roam to a preferred roamed-to-network indicated by the HPLMN.

Steering of Roaming application function (SOR-AF) is an application function that can provide UDM with one of the following:
a) one or more of the following:
list of preferred PLMN/access technology combinations;
SOR-CMCI, together with the “Store SOR-CMCI in ME” indicator if applicable;
SOR-SNPN-SI;
b) a secured packet, together with the indicator, if applicable, that “the list of preferred PLMN/access technology combinations is not included in the secured packet”; or
c) neither of a) or b),
generated dynamically based on operator specific data analytics solutions.

Steering of Roaming information consists of the following HPLMN or subscribed SNPN protected information:
a) the following indicators, of whether:
the UDM requests an acknowledgement from the UE for successful reception of the steering of roaming information.
the UDM requests the UE to store the SOR-CMCI in the ME, which is provided along with the SOR-CMCI in plain text; and
b) one of the following:
1) one or more of the following:
list of preferred PLMN/access technology combinations with an indication that it is included;
SOR-CMCI; or
SOR-SNPN-SI;
2) a secured packet with an indication that it is included;
3) the HPLMN indication that ‘no change of the “Operator Controlled PLMN Selector with Access Technology” list stored in the UE is needed and thus no list of preferred PLMN/access technology combinations is provided’; or
4) the subscribed SNPN or HPLMN indication that ‘no change of the SOR-SNPN-SI stored in the UE is needed and thus no SOR-SNPN-SI is provided’.

Steering of roaming connected mode control information (SOR-CMCI): HPLMN information to control the timing for a UE in connected mode to move to idle mode in order to perform steering of roaming.

Steering of roaming SNPN selection information (SOR-SNPN-SI): Provisioning information for SNPN selection consisting of:
a) the credentials holder controlled prioritized list of preferred SNPNs;
b) the credentials holder controlled prioritized list of GINs; or
c) both of the above.

### 1. SOR Transparent Container

The purpose of the SOR transparent container information element in the REGISTRATION ACCEPT message is to provide the list of preferred PLMN/access technology combinations (or HPLMN indication that ‘no change of the “Operator Controlled PLMN Selector with Access Technology” list stored in the UE is needed and thus no list of preferred PLMN/access technology combinations is provided’), or a secured packet (see 3GPP TS 23.122 [5] annex C) and optional indication of an acknowledgement request, SOR-CMCI, request the storage of the received SOR-CMCI in the ME, and SOR-SNPN-SI (or subscribed SNPN or HPLMN indication that ‘no change of the SOR-SNPN-SI stored in the UE is needed and thus no SOR-SNPN-SI is provided’). The purpose of the SOR transparent container information element in the REGISTRATION COMPLETE message is to indicate the UE acknowledgement of successful reception of the SOR transparent container IE in the REGISTRATION ACCEPT message as well as to indicate the ME support of SOR-CMCI and the ME support of SOR-SNPN-SI.

When used in NAS transport procedure, the contents of the SOR transparent container information element in the Payload container IE of the DL NAS TRANSPORT message are used to provide the list of preferred PLMN/access technology combinations and optional indication of an acknowledgement request, SOR-CMCI, request the storage of the received SOR-CMCI in the ME, and SOR-SNPN-SI. The contents of the SOR transparent container information element in the Payload container IE of the UL NAS TRANSPORT message are used to indicate the UE acknowledgement of successful reception of the SOR transparent container IE in the DL NAS TRANSPORT message as well as to indicate the ME support of SOR-CMCI and the ME support of SOR-SNPN-SI.

The legacy SoR procedure may be performed when a UE successfully registers. For example, the Serving PLMN sends SoR information to a UE via a REGISTRATION ACCEPT message, and the UE may send a REGISTRATION COMPLETE message to inform SoR related information to the network.

Previously, SOR information was included in the registration accept message and transmitted to the terminal. Later, when the terminal selected a PLMN, it selected the PLMN based on the SOR information.

However, in some scenarios, the network operator may want a particular UE to register to another network rather than allowing the registration request.

For example, there is on-going discussion that different network operators may support different types of services or different groups of UEs when multiple network operators can serve an area.

Then, a network may reject the UE registration request but the existing SoR procedure based network selection cannot be used because the registration procedure fails.

If the registration procedure fails, the network may send roaming assistant information (e.g., SOR information) to the UE along with a registration reject message.

The UE may then perform network (PLMN) selection based on the roaming assistant information (e.g., SOR information).

The network may indicate a specific rejection reason. This allows the UE to perform network selection based on the Roaming Assistant information when receiving a registration reject.

The network may indicate a specific rejection reason to the UE through the roaming assistant information included in the registration rejection.

In this specification, a network selection failure may occur when the UE requests registration on the selected network but is rejected, or when the UE fails to complete the registration request. Conversely, a network selection success may occur when the UE registers on the selected network.

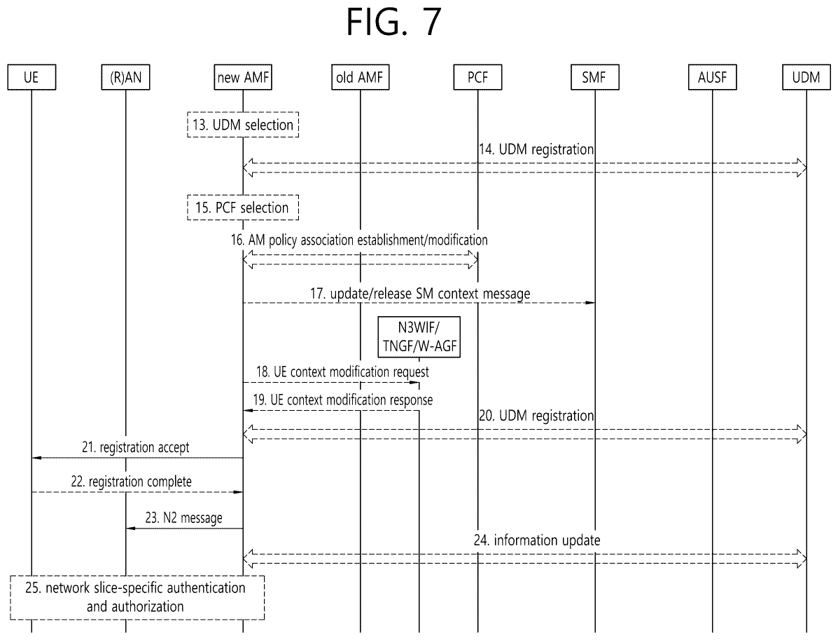

FIG. 8 shows a procedure according to an embodiment of the present specification.

A UE may send a registration request message to a serving network (VPLMN).

Here, the serving network may refer to the network to which the UE transmitted the registration request message. For example, the serving network may be the network selected by the UE for registration.

The registration request message may include UE support information.

The support information may be information regarding the capability information of the UE. The capability information may be a 5GMM capability parameter.

Alternatively, the support information may be a support indication. The support indication may be included in a SoR transparent container for receiving roaming assistant information.

The support information may include information indicating support for an enhanced reject procedure. The support for enhanced reject procedure may indicate that the UE can interpret roaming assistant information when it receives a registration failure indication from the network.

The registration request message may include UE assistant information. UE assistant information may include UE type and prioritized services.

The serving network may transmit UE information (UE assistant information) to the home network (HPLMN).

The serving network may receive a UE assistant command from the home network. The serving network may receive roaming assistant information for the UE from the home network.

The serving network may then transmit the roaming assistant information to the UE. The roaming assistant information may be in the form of a SOR. For example, the SOR-AF of the home network may generate an SOR including the roaming assistant information. The generated SOR may be transmitted to the UE via the serving network.

If the UE receives a registration failure indication from the network, the UE may indicate support (or support information) for the UE's ability to interpret the roaming assistant information.

The UE may signal its UE capability (or support information) to the network. The UE capability (or support information) may include information indicating that the UE can interpret roaming assistant information when receiving a registration failure indication from the network.

The UE capability indication (or support information) may be UE function information included in a registration request message. The UE capability indication (or support information) may be an indication to the network during a SoR procedure.

The UE capability (or support information) may be included in the registration request message and transmitted to the network.

The UE capability (or support information) may be transmitted to the network during a SOR procedure.

The UE may signal its UE assistant information to the network so that the serving network and/or the home network can provide roaming assistant information during a registration failure procedure.

The serving network may transmit the UE assistant information to the HPLMN.

If the serving network determines that roaming assistant information based on the UE's subscription is required, the serving network may transmit UE assistant information to the HPLMN upon receiving a registration request. The UE assistant information may include a request for roaming assistant information for the UE.

The serving network may receive a UE assistant command from the HPLMN. The UE assistant command may include roaming assistant information. The roaming assistant information may be based on the UE's subscription information.

The serving network (VPLMN) may send a registration rejection message to the UE. The registration rejection message may include roaming assistant information and a rejection cause.

The roaming assistant information may include PLMN (or SNPN) information, network slice information, validity time information, feature based roaming information, and feature priority.

The rejection cause may include information indicating that network controlled network selection is required.

The network may transmit roaming assistant information to the UE via SoR information along with a registration failure indication. The roaming assistant information may be SoR information. The roaming assistant information may be an SoR transparent container information element.

Alternatively, the network may transmit roaming assistant information to the UE along with a registration failure indication. In this case, the roaming assistant information may not be based on SOR information.

The registration failure may be a registration rejection. The registration failure indication may be a registration rejection message.

The roaming assistant information may be included in a registration rejection message and transmitted to the UE.

Alternatively, the network may transmit roaming assistant information (supported network information) to the RAN node. The RAN node may broadcast network information (e.g., roaming assistant information categorized by service). The UE may store the broadcasted information as network-controlled roaming assistant information.

The network may notify the UE of the need for a network selection trigger through the network-controlled roaming assistant information. Here, the network selection (which is a target of the trigger) may be network-controlled network selection.

Alternatively, the network may notify the UE of the need for a network selection trigger through a separate indication. Here, the network selection (which is a target of the trigger) may be network-controlled network selection.

The roaming assistant information may be information received by the UE during a registration failure. Furthermore, the UE may store roaming assistant information. For example, the UE may receive roaming assistant information from the network. The UE may already store roaming assistant information. The UE may store roaming assistant information received from the network as roaming assistant information by adding it to the previously stored roaming assistant information.

The UE may receive a registration rejection message including a registration rejection cause. The registration rejection cause may include information indicating that network-controlled network selection is required.

The UE may trigger a network selection procedure based on the roaming assistant information and/or the rejection cause indicating network-controlled network selection.

Network-controlled network selection may refer to network selection by the UE controlled by the network. For example, if the UE receives network-controlled roaming assistant information along with a registration rejection, the UE may perform network-controlled network selection based on the network-controlled roaming assistant information.

The registration procedure illustrated in FIG. 8 may include initial registration, periodic registration, and mobility registration update cases.

Roaming Assistant Information may refer to information received during the registration procedure for Network-1. Roaming Assistant Information may include all roaming information received from all networks (Network 1 or other) and roaming information pre-configured in the UE. Roaming may include network changes (e.g., PLMN, SNPN).

According to an embodiment of the present specification, the following steps 1 to 4 may be performed.

Step 1. The UE may transmit a registration request message to the network to attempt registration or registration update.
Upon receiving a registration failure indication from the network, the UE may indicate its support for interpreting the roaming assistant information using UE capability information (or support information). The UE capability indication (or support information) may be UE capability information (or support information) included in the registration request message.
The UE may transmit UE assistant information to the network. UE Assistant information may indicate the type of UE device (e.g., RedCap UE). UE Assistant information may indicate prioritized service information (e.g., gaming, V2X).
UE capability indication (or support information) or UE Assistant information may be transmitted to the network via NAS signaling or AS signaling. If the information is transmitted via AS signaling, the RAN node may forward the information to the AMF.

Step 2. The UE may receive a registration reject message.
The UE may receive roaming assistant information during the registration reject.
The network may include SoR information in the registration reject message.
The roaming assistant information may include feature-specific roaming information (e.g., slice-aware roaming, location-aware roaming). The network may include feature indications that prioritize roaming.
The network list in the roaming assistant information may be indicated for differentiated UE control. For example, PLMN-1 may be deprioritized by the UE during the network selection procedure.
The UE may receive a reject cause indicating that network controlled network selection is required. The rejection cause may be “#11 PLMN not allowed,” “#62 No network service available,” or “#xx network controlled network selection required.” Upon receiving rejection cause #xx, the UE may trigger network selection based on Network controlled roaming assistant information.

Step 3. The UE may perform network selection.
The UE may perform network selection based on Roaming assistant information received during the registration procedure. If the UE receives feature priority information, the UE may attempt network selection based on prioritized features. If feature-based network selection (registration to the selected network) fails (if network selection considering feature priority information fails), the UE may fall back to legacy network selection (and perform legacy network selection). Network selection failure may occur when the UE requests registration on the selected network but is rejected, or when the UE fails to perform the registration request. Conversely, network selection success may occur when the UE registers on the selected network.
The UE may perform network selection based on pre-configured roaming information (e.g., USIM information).
The UE may perform network selection based on stored roaming information.
The UE may store the current network identifier in a list of deprioritized networks (e.g., forbidden PLMNs, not allowed PLMNs in this area). If the UE falls back to legacy network selection, it may include this network in its network selection.

Step 4. The UE may fall back to legacy network selection.
Legacy network selection may be network selection not based on Roaming Assistant information.
If Roaming Assistant information-based network selection (registration to the selected network) fails, the UE may perform legacy network selection. Network selection may be performed without considering Roaming Assistant information.
If network selection (registration to the selected network) based on Roaming Assistant information fails, the UE may remove stored Roaming Assistant information.
The UE may notify the network selected by the new network selection (legacy network selection) that the previous network selection (step 3) (e.g., network selection using Roaming Assistant information and registration to the selected network) failed.

Even if registration fails, the UE may receive recent Roaming Assistant information from the serving network and perform efficient network selection based on UE information or current network conditions.

For example, in a deployment scenario where multiple PLMNs/networks are available, if the UE selects a non-preferred network, the network operator may control the UE's network selection behavior even if the network does not allow UE registration.

In this specification, roaming assistant information may include SoR technology that provides assistant information to enable the HPLMN to roam a roaming UE to a specific network.

Roaming assistant information may be in the form of SOR enhancements or SoR.

Roaming assistant information may be information provided by another network entity in a form other than SOR enhancements or SoR.

In this specification, the feature priority information included in the roaming assistant information may encompass the full range of characteristics required for functional implementation.

For example, the feature may be for network slicing or MUSIM.

For example, the feature may be for network slice usage control used in network slicing.

For example, the feature may be for coverage enhancements (CE) for IoT.

When a terminal selects a network, the terminal may perform network selection by prioritizing services required by the terminal.

In this specification, when a terminal selects a network, the terminal may perform network selection by prioritizing features supported by the network.

In this specification, when a terminal selects a network, the terminal may perform network selection by prioritizing features supported by the network and services required by the terminal.

In this specification, when a terminal performs network-controlled network selection, the terminal may perform network selection based on roaming assistant information received from the network.

For example, the roaming assistant information received by the terminal may prioritize the first PLMN, while the information stored in the terminal may prioritize the second PLMN.

When the terminal performs network-controlled network selection, the terminal may perform network selection by prioritizing the first PLMN over the second PLMN.

The terminal may attempt to register with the network by including UE assistant information. Here, the UE assistant information may include UE capability, UE type, or priority services. The UE may receive roaming assistant information or network control network selection indication during registration reject. The UE may perform network selection based on the roaming assistant information.

The drawings below are created to illustrate specific examples of the present specification. The names of specific devices or names of specific signals/messages/fields depicted in the drawings are presented as examples, and therefore the technical features of the present specification are not limited to the specific names used in the drawings below.

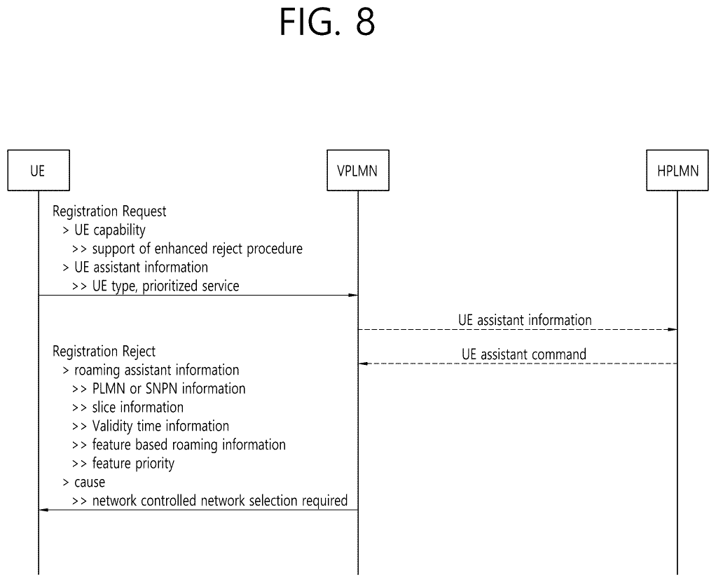

FIG. 9 shows the procedure of the UE according to disclosure of the present specification.

1. The UE may transmit, to a Visited Public Land Mobile Network (VPLMN), a registration request message.

2. The UE may receive, from the VPLMN, a registration reject message.

The registration reject message may include roaming assistant information.

3. The UE may perform network selection, based on the roaming assistant information. The registration request message may include assistant information of the UE.

The assistant information of the UE may include information indicating that the UE can interpret roaming assistant information when receiving a registration reject message.

The roaming assistant information may be Steering of Roaming (SoR) transparent container information.

The registration request message may include assistant information of the UE.

The assistant information of the UE may include a type of the UE or prioritized service.

The UE may delete the roaming assistant information, based on the failure of the network selection.

The UE may perform a registration procedure with a network selected by the network selection.

The UE may perform new network selection, based on the failure of the registration procedure with the network selected by the network selection.

The new network selection may be not based on the roaming assistant information.

The UE may delete the roaming assistant information, based on the failure of the registration procedure with the network selected by the network selection.

The UE may transmit, to a network selected by the new network selection, a new registration request, based on the failure of the registration procedure with the network selected by the network selection.

The new registration request may include information that the registration procedure with the network selected by the network selection has failed.

The drawings below are created to illustrate specific examples of the present specification. The names of specific devices or names of specific signals/messages/fields depicted in the drawings are presented as examples, and therefore the technical features of the present specification are not limited to the specific names used in the drawings below.

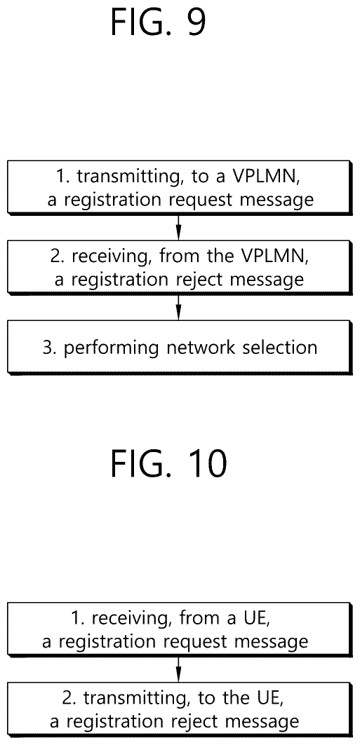

FIG. 10 shows the procedure of the VPLMN according to disclosure of the present specification.

1. The VPLMN may receive, from a UE, a registration request message.

2. The VPLMN may transmit, to the UE, a registration reject message.

The registration reject message may include roaming assistant information.

The registration request message may include assistant information of the UE.

The assistant information of the UE may include information indicating that the UE can interpret roaming assistant information when receiving a registration reject message.

The roaming assistant information may be Steering of Roaming (SoR) transparent container information.

The registration request message may include assistant information of the UE.

The assistant information of the UE may include a type of the UE or prioritized service.

The VPLMN may transmit, to a Home PLMN (HPLMN), the assistant information of the UE.

The VPLMN may receive, from the HPLMN, information based on the subscription of the UE, based on the assistant information of the UE.

Hereinafter, an apparatus for performing communication according to some embodiments of the present specification will be described.

For example, a target V-SMF may include a processor, a transceiver, and a memory.

For example, a processor may be configured to be operably coupled with a memory and a processor.

The processor may perform: transmitting, to a Visited Public Land Mobile Network (VPLMN), a registration request message; receiving, from the VPLMN, a registration reject message; and wherein the registration reject message includes roaming assistant information, performing network selection, based on the roaming assistant information.

Hereinafter, a processor for providing communication according to some embodiments of the present specification will be described.

The processor is configured to: transmitting, to a Visited Public Land Mobile Network (VPLMN), a registration request message; receiving, from the VPLMN, a registration reject message; and wherein the registration reject message includes roaming assistant information, performing network selection, based on the roaming assistant information.

Hereinafter, a non-volatile computer readable medium storing one or more instructions for providing multicast service in wireless communication according to some embodiments of the present specification will be described.

According to some embodiments of the present disclosure, the technical features of the present disclosure may be directly implemented as hardware, software executed by a processor, or a combination of the two. For example, in wireless communication, a method performed by a wireless device may be implemented in hardware, software, firmware, or any combination thereof. For example, the software may reside in RAM memory, flash memory, ROM memory, EPROM memory, EEPROM memory, registers, hard disk, removable disk, CD-ROM, or other storage medium.

Some examples of a storage medium are coupled to the processor such that the processor can read information from the storage medium. Alternatively, the storage medium may be integrated into the processor. The processor and storage medium may reside in the ASIC. For another example, a processor and a storage medium may reside as separate components.

Computer-readable media can include tangible and non-volatile computer-readable storage media.

For example, non-volatile computer-readable media may include random access memory (RAM), such as synchronization dynamic random access memory (SDRAM), read-only memory (ROM), or non-volatile random access memory (NVRAM). Read-only memory (EEPROM), flash memory, magnetic or optical data storage media, or other media that can be used to store instructions or data structures or Non-volatile computer readable media may also include combinations of the above.

Further, the methods described herein may be realized at least in part by computer-readable communication media that carry or carry code in the form of instructions or data structures and that can be accessed, read, and/or executed by a computer.

According to some embodiments of the present disclosure, a non-transitory computer-readable medium has one or more instructions stored thereon. The stored one or more instructions may be executed by a processor of the base station.

The stored one or more instructions cause the processors to: transmitting, to a Visited Public Land Mobile Network (VPLMN), a registration request message; receiving, from the VPLMN, a registration reject message; and wherein the registration reject message includes roaming assistant information, performing network selection, based on the roaming assistant information.

The present specification may have various effects.

For example, unnecessary procedures can be omitted through the procedures disclosed in this specification.

Effects that can be obtained through specific examples of the present specification are not limited to the effects listed above. For example, various technical effects that a person having ordinary skill in the related art can understand or derive from this specification may exist. Accordingly, the specific effects of the present specification are not limited to those explicitly described herein, and may include various effects that can be understood or derived from the technical characteristics of the present specification.

The claims described herein may be combined in various ways. For example, the technical features of the method claims of the present specification may be combined and implemented as an apparatus, and the technical features of the apparatus claims of the present specification may be combined and implemented as a method. In addition, the technical features of the method claim of the present specification and the technical features of the apparatus claim may be combined to be implemented as an apparatus, and the technical features of the method claim of the present specification and the technical features of the apparatus claim may be combined and implemented as a method. Other implementations are within the scope of the following claims.

1. A method, comprising:
transmitting, by a User Equipment (UE) to a Visited Public Land Mobile Network (VPLMN), a registration request message;
receiving, by the UE from the VPLMN, a registration reject message; and
wherein the registration reject message includes roaming assistant information,
performing, by the UE, network selection, based on the roaming assistant information.

2. The method of claim 1,
wherein the registration request message includes assistant information of the UE,
wherein the assistant information of the UE includes information indicating that the UE can interpret roaming assistant information when receiving a registration reject message.

3. The method of claim 1,
wherein the roaming assistant information is Steering of Roaming (SoR) transparent container information.

4. The method of claim 1,
wherein the registration request message includes assistant information of the UE,
wherein the assistant information of the UE includes a type of the UE or prioritized service.

5. The method of claim 1, further comprising:
deleting, by the UE, the roaming assistant information, based on the failure of the network selection.

6. The method of claim 1, further comprising:
performing, by the UE, a registration procedure with a network selected by the network selection; and
performing, by the UE, new network selection, based on the failure of the registration procedure with the network selected by the network selection,
wherein the new network selection is not based on the roaming assistant information.

7. The method of claim 6, further comprising:
deleting, by the UE, the roaming assistant information, based on the failure of the registration procedure with the network selected by the network selection.

8. The method of claim 6, further comprising:
transmitting, by the UE, to a network selected by the new network selection, a new registration request, based on the failure of the registration procedure with the network selected by the network selection,
wherein the new registration request includes information that the registration procedure with the network selected by the network selection has failed.

9. A method, comprising:
receiving, by a VPLMN from a UE, a registration request message; and
transmitting, by the VPLMN to the UE, a registration reject message,
wherein the registration reject message includes roaming assistant information.

10. The method of claim 9,
wherein the registration request message includes assistant information of the UE,
wherein the assistant information of the UE includes information indicating that the UE can interpret roaming assistant information when receiving a registration reject message.

11. The method of claim 9,
wherein the roaming assistant information is Steering of Roaming (SoR) transparent container information.

12. The method of claim 9,
wherein the registration request message includes assistant information of the UE,
wherein the assistant information of the UE includes a type of the UE or prioritized service.

13. The method of claim 12,
transmitting, by the VPLMN to a Home PLMN (HPLMN), the assistant information of the UE; and
receiving, by the VPLMN from the HPLMN, information based on the subscription of the UE, based on the assistant information of the UE.

14. A UE, comprising:
at least one memory; and
at least one processor operably connectable to the at least one memory,
wherein the at least one memory stores instructions that, based on being executed by the at least one processor, cause the at least one processor to perform operations comprising:
transmitting, to a Visited Public Land Mobile Network (VPLMN), a registration request message:
receiving, from the VPLMN, a registration reject message; and
wherein the registration reject message includes roaming assistant information,
performing network selection, based on the roaming assistant information.

15-17. (canceled)

18. The UE of claim 14,
wherein the registration request message includes assistant information of the UE,
wherein the assistant information of the UE includes information indicating that the UE can interpret roaming assistant information when receiving a registration reject message.

19. The UE of claim 14,
wherein the roaming assistant information is Steering of Roaming (SoR) transparent container information.

20. The UE of claim 14,
wherein the registration request message includes assistant information of the UE,
wherein the assistant information of the UE includes a type of the UE or prioritized service.

21. The UE of claim 14, wherein the operation further comprises:
deleting the roaming assistant information, based on the failure of the network selection.

22. The UE of claim 14, wherein the operation further comprises:
performing a registration procedure with a network selected by the network selection; and
performing new network selection, based on the failure of the registration procedure with the network selected by the network selection,
wherein the new network selection is not based on the roaming assistant information.

23. The UE of claim 14, wherein the operation further comprises:
deleting the roaming assistant information, based on the failure of the registration procedure with the network selected by the network selection,
